(19) United States
(12) Patent Application Publication
(10) Pub. No.: US 2026/0278506 A1
(43) Pub. Date: Sep. 17, 2026

(54) METHOD AND SYSTEM FOR MULTI-AGENT AI SYSTEM FOR MULTI-PARTNER OFFERING CREATION, BUSINESS PROCESS AUTOMATION, AND API INTEGRATION

(71) Applicant: Nishi Kant, Pleasanton, CA (US)

(72) Inventor: Nishi Kant, Pleasanton, CA (US)

(73) Assignee: Digitize Things Inc., Newark, CA (US)

(21) Appl. No.: 19/082,141

(22) Filed: Mar. 17, 2025

(51) Int. Cl. G06Q 10/0633; G06Q 10/0631; G06Q 30/018; G06Q 30/0601

(52) U.S. Cl. CPC G06Q 10/0633; G06Q 10/063118; G06Q 30/018; G06Q 30/0619

(57) ABSTRACT

The invention provides a Multi-Agent AI system automating the creation, configuration, and management of multi-partner product and service offerings, associated workflows, and API integrations. The system leverages natural language processing to interpret unstructured descriptions, identifying product or service components and their interrelationships, generating a structured definition of the multi-partner solution. Utilizing natural language inputs, the system creates executable workflows represented in a machine-processable format, such as Business Process Model and Notation (BPMN), orchestrating fulfillment actions across enterprise and partner systems. Additionally, the system automatically analyzes enterprise and partner API documentation to dynamically generate software connectors, facilitating automated transactions and service execution. An integrated workflow execution engine manages the complete lifecycle of the multi-partner offering, including fulfillment, modifications, and partner coordination. This approach significantly enhances automation, minimizes manual integration tasks, and expedites scalable deployment of complex multi-partner solutions through adaptive workflows and integrations.

### FIELD OF THE INVENTION

The present invention relates to the field of software automation, artificial intelligence, and enterprise software systems. Specifically, it pertains to the application of Multi-Agent AI system for creating and managing multi-partner offerings, generating their associated business workflows, and systematically interpreting APIs for seamless integration with partner systems.

### BACKGROUND

Modern enterprises frequently engage in multi-partner business collaborations where products and services from different partners are combined to create a unified solution. These components have their description (text and visual), specifications and often have associated rules and dependencies. A product manager collates information about each component, organizes it in a corresponding bundle while observing the applicable rules and then saving it in the business application responsible for its lifecycle. While figuring out relevant information and dynamically deciding dependencies is relatively straightforward for humans, it becomes quite hard to automate that programmatically. As more offerings are added or as offerings are updated, lack of automation limits the scale.

Once products have been created and published, they are typically sold using a sales process. This may involve creating a quote and obtaining necessary approvals (e.g. from management and the customer). This is followed by order processing and fulfilment. Since enterprises may have different processes, the business-software typically allows such process to be configured as executable workflows which in turn drives the quote or an order process. Products offerings, especially sophisticated product bundles in a multi-partner scenario need dedicated processes. Such processes are defined by the operations team and configured by personnel with access to and understanding of the business-software configuration options. Often people who define the process and those who configure the software are different people. This not only leads to back and forth, but it also slows down the business cycle. After a while configuring the software becomes a mundane task. Therefore, both from business-cycle agility and quality of work perspective, it is desirable that the person defining the process can accomplish this via natural language interaction with the system.

Often the business software applications need to interface and interact with other software systems. Typically, this is achieved using API (Application Programming Interface) in modern systems. In a multi-partner scenario, it is a given that system managing the life-cycle of such offerings will need to interface with existing systems including some from the partners. Many popular business software applications such as SAP, Salesforce, Service Now etc. have a large set of published APIs. Interaction, using these APIs typically, requires establishment of security association and then the relevant API is called with correct parameters. Some applications have different families of APIs available, based on how that software has evolved over the years. Thus, despite having published information, there is a learning curve for software developers to get the interaction working. Secondly, testing such interaction requires covering edge and error cases which often get ignored. There is a much larger scope for automation in API interaction and associated testing.

Modern enterprises are increasingly leveraging Multi-Agent AI system to handle complex, multi-domain processes that traditionally required extensive human coordination. In a multi-agent architecture, specialized AI agents collaborate under a unified orchestration to achieve shared objectives. This approach is especially valuable for managing multi-partner product/service offerings, which bundle complementary products from different companies into unified solutions. Such bundling can greatly enhance customer value and convenience, as businesses can combine “as-a-service” products from different vendors into comprehensive packages (IT Bundles). However, manually configuring and managing these multi-partner offerings through their lifecycle becomes tedious and complex as offerings and products grow. Similarly, translating high-level business processes into executable workflows and integrating diverse external systems are challenging tasks.

Recent advances show promise in these areas—for example, AI tools can now turn natural-language process descriptions into BPMN workflow models, and integration platforms like Boomi leverage AI to suggest integration process designs (U.S. Pat. Nos. 11,886,965 and 11,847,167). OpenAI has even patented techniques for dynamically linking external APIs into natural language AI interfaces (U.S. Pat. Nos. 11,922,144 and 12,124,823). Yet, no single system to date unifies multi-partner offer configuration, automatic BPMN workflow generation, and API integration into one AI-driven solution. This invention fills this gap with a Multi-Agent AI system that automates the end-to-end process: from defining a multi-partner offering, through generating its execution workflow, to discovering and connecting the necessary external APIs. This innovative platform aims to dramatically reduce manual effort, accelerate time-to-market for partner bundles, and ensure seamless coordination across enterprises and their partners to increase business agility and achieve a much higher degree of automation. That is the subject of this invention.

### SUMMARY OF THE INVENTION

The present invention provides a Multi-Agent AI system for automating the creation, configuration, and integration of multi-partner product/service offerings. The system leverages natural language processing (NLP), business process modeling (BPMN), and automated API integration to accelerate multi-vendor solution deployment while minimizing manual intervention as a capability in a target business software application. The system includes multiple AI agents collaborating for:
1. Automated Offering Creation:
   The system accepts a natural language description of a multi-partner offering, including component relationships and relevant URLs.
   A generative AI agent, pre-trained on structured offerings from the target system, interprets the description and scrapes digital sources for additional details.
   The AI agent produces a JSON object representing the offering, formatted for import into the target application.
2. Component Verification and Creation in the Target System:
   The AI agent queries the target system's catalog to determine if all necessary components exist.
   If components are missing, the agent autonomously triggers API calls to create them in the system.
   Once the offering is fully assembled, it is registered in the catalog for further processing.
3. API-Based Integration with Partner ERP Systems:
   When an offering includes partner-specific components, order fulfillment requires integration with the partner's ERP system.
   A second AI agent is tasked with generating the required connector based on API documentation or Swagger specifications.
   The AI agent determines the authentication methods, required tokens, and API call sequences for seamless interaction with partner systems.
4. Lifecycle Orchestration with BPMN Workflows:
   Business processes related to offerings, such as approval workflows, CPQ (Configure, Price, Quote), and fulfillment, are described in natural language.
   The AI agent converts these descriptions into BPMN-compliant workflows suitable for execution in the target system.
   Prior structured workflows from the target system are used to fine-tune the AI agent, ensuring accurate mapping of APIs to process steps.
   The AI selects appropriate API endpoints and state transitions required for workflow execution.
5. API Categorization for efficient selection of correct API for integration:
   The target system and partner ERP systems may have large and complex API sets.
   A dedicated AI agent scans API documentation and organizes API signatures into functional categories.
   Categorized APIs allow other AI agents to quickly locate necessary functions without processing entire documentation sets, improving performance and accuracy.
   The dedicated AI Agent updates the categorized index as new APIs are published or as new systems are integrated.

### PRIOR ART AND NOVELTY CONSIDERATIONS

Multi-Partner Offer Management: Traditional product bundling tools (CPQ systems, marketplaces like AppDirect) support multi-vendor bundles but rely on manual configuration. Some telecom solutions (e.g. Conga's telecom platform) mention multi-partner offering support via open APIs (Telecommunication—Salesforce AppExchange), yet these do not describe AI automation of bundle creation from natural language. There is no prior patent specifically on AI parsing textual bundle descriptions into structured offerings. The approach for this invention stands out by using NLP to automate what has been a manual, expert-driven task, therefore addressing a long-felt need for agility in partner marketing.

AI-Generated Workflows: There is active research on using AI (especially LLMs) to generate process models. A recent framework uses multiple LLM agents to iteratively refine BPMN models from text (MAO: A Framework for Process Model Generation with Multi-Agent Orchestration), indicating the feasibility and novelty of the Workflow Agent as per this invention. Bonitasoft's AI BPMN generator is a commercial example that “leverages NLP to understand your prompts and generate a process model”, validating that part of the concept. However, none of these provide full integration into execution system or dynamic coordination with an offering configuration. The system's ability as per this invention, to immediately execute the AI-generated BPMN on real systems (through connectors) is a differentiator extending orchestration into the end-to-end execution.

API Integration Automation: The closest prior art here includes integration-platform patents and AI assistants. Notably, Boomi's U.S. Pat. No. 11,886,965 (2023) covers AI-assisted construction of integration processes, using ML to suggest how to connect applications. This invention is distinct: Boomi's innovation guides human users in building integrations, whereas the Integration Agent as per this invention, autonomously builds the connectors. Another relevant patent is OpenAI's “schema-based integration of external APIs with natural language applications”, which is about an AI dynamically integrating an external API in response to a user's request. This highlights the importance of simplifying API integration—the system as per this invention, similarly, identifies and integrates APIs, but as part of a design-time process for workflow automation. No known prior system auto-generates a library of connectors by reading API docs across multiple partners. This novelty is emphasized in claims (e.g. an AI that parses API documentation to generate executable integration adapters-a clear technical improvement in software development automation).

Multi-Agent Orchestration: Multi-agent AI systems themselves are a growing area, with some patents (like C3.ai's U.S. Pat. No. 12,111,859) and frameworks (e.g. Microsoft's “Jarvis” agent framework, Amazon Bedrock's agents, etc.) focusing on orchestrating LLM-based agents for general tasks. These underscore that multi-agent AI is patent-eligible. The novelty in this invention is in the specific combination of agent roles and their application to a new problem space (partner offering automation). This invention introduces an enhanced orchestrator that coordinates domain-specific agents (NLP offer agent, BPMN agent, API agent)—this architecture can be claimed in a manner distinct from generic orchestrators by tying it to the functional steps of offer configuration, workflow generation, and integration. Finally, linking these Multi-Agent AI agents to a common workspace or repository, which could be a shared database, an ERP application, or another collaborative system, facilitates consistent information sharing and verification for an end to end transaction. While this invention is described with ERP application as the shared workspace, it should be clear to the skilled in the art that notion of such shared workspace is generic, and same outcome can be achieved irrespective of method chosen.

In summary, this invention is at the intersection of three areas where AI is innovating, but no single reference or combination teaches integrating all three to achieve higher and more productive automation with use a shared workspace among Multi-Agents. This invention solves a unique technical challenge: automating the configuration-to-execution pipeline for multi-partner offerings. This yields concrete benefits—faster rollout of complex service bundles, error reduction through consistent AI interpretation, and scalable integration of new partners—that were not possible with siloed tools. The shared workspace further enables independent audit and validation of completed tasks by Multi-Agent AI system.

### BRIEF DESCRIPTION OF THE DRAWINGS

FIG. 1. depicts a traditional way how a multi-partner offering is composed in a business application. Here the product manager describes the offering in terms of constituent products or services and their respective specifications.

FIG. 2. shows how a Multi-Agent AI system can create a multi-partner offering with a given natural language description of the offering and a set of documentation or web addresses (URLs) as per an embodiment of this invention.

FIG. 3. shows traditional way of modeling processes as workflows representing various aspects of business activities. The business application with a run-time module executes the workflow when required.

FIG. 4. shows how a Multi-Agent AI system can create a workflow from natural language description as per an embodiment of this invention.

FIG. 5. shows traditional way a developer writes code for creating a connector for API based integration of two systems.

FIG. 6. shows how a Multi-Agent AI system, as per an embodiment of this invention, first creates categorized index of APIs and then creates a connector for integration between systems, both in response to natural language instructions.

FIG. 7 is a block diagram of an exemplary computer implementation that could be used by embodiments of this invention.

### DETAILED DESCRIPTION OF THE INVENTION

The proposed system based in this invention, consists of multiple cooperating AI components (agents) specialized in distinct tasks, orchestrated to work together as an intelligent whole. The three core functional aspects are:

### 1. Multi-Partner Offering Configuration and Lifecycle Management

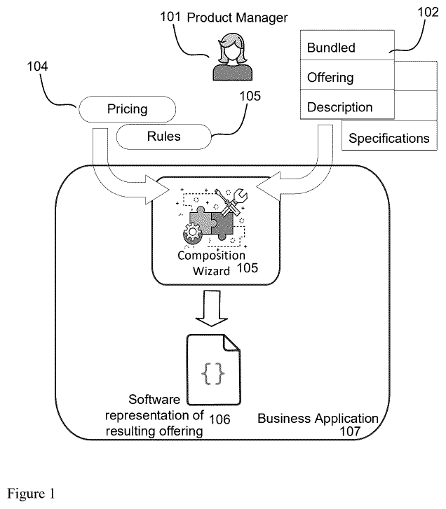

Configuring a multi-partner offering involves defining a product/service bundle that spans multiple partner organizations. As shown in FIG. 1, a multi-partner product/service bundle (101) consists of individual products/services (102), pricing definitions (103), associated partner metadata (104), and is stored using a software module with a suitable user interface (105) in the business application (107).

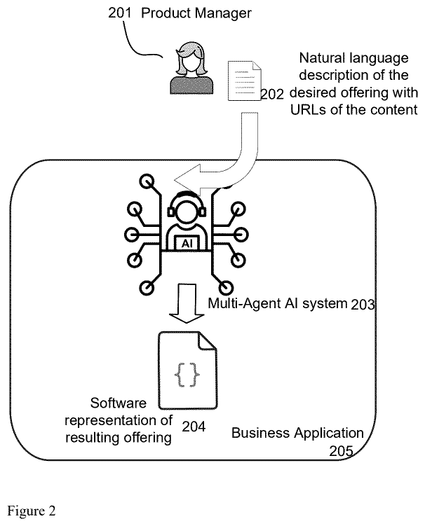

This invention introduces an AI Offer Configuration Agent that automates this process. It uses natural language processing (NLP) to interpret unstructured descriptions of an offering (e.g. a text description of a new bundle from a product manager) and generates a structured offering definition. This structured definition could be a formal data model capturing each component product/service, partner provider, pricing, dependencies, and business rules. Referring to FIG. 2, the AI-driven offering creation process begins when a user submits a natural language description (202) containing key product/service attributes and reference URLs (203). The Multi-Agent AI system (205) processes this input, extracting structured information and dependencies to generate a structured offering model (204) for import into the business application. To illustrate, a user might input: “Bundle a 12-month subscription of Partner A's streaming service with our fiber internet plan and a Partner B smart home device at a 20% discount for first 6 months.” The AI agent will parse this and produce a structured representation (e.g. JSON or an XML schema) detailing the bundle's components, promotional pricing rules, involved partner systems, etc. NLP-driven parsing of product bundling rules allows business users to describe offers in plain language, leaving the AI to handle the formalization. This is a novel approach compared to current CPQ (Configure-Price-Quote) systems which require manual entry of each bundle component and rule.

Crucially, the Multi-Agent AI system's Offer Configuration Agent interacts seamlessly with enterprise and partner systems via dynamically generated API connectors to manage the entire lifecycle of an offering. For example, it can interface with the company's product catalog and ERP for pricing and inventory, and with partner APIs for availability or provisioning info. The agent continuously synchronizes updates-if a partner changes a service (say Partner A updates their streaming package), the AI can automatically adjust the bundle definition or notify managers. Lifecycle management is thereby automated, ensuring the multi-partner offering remains up-to-date and compliant with each partner's terms. This addresses the complexity noted in industry: offering multiple services as one package is beneficial but requires careful coordination and data sharing (IT Bundles). By using an AI to handle these tasks, the system reduces errors and speeds up the launch of new partner bundles.

From a multi-agent perspective, the offering configuration agent is one “expert” in the system, focused on bundling logic and partner data. Its output (the structured offer) will drive the next stages of automation. Notably, this approach can apply across industries—e.g. telecommunications bundling of TV+internet+phone, Internet of Things bundling of device, application and connectivity, fintech partnerships bundling bank accounts with investment services, or e-commerce bundles of third-party products.

Aspects of the invention herein include methods where a finetuned Multi-Agent AI system, by leveraging natural language descriptions can autonomously extract relevant product/service details when pointed to existing documentation or URLs with information and create multi-partner offerings.

### 2. AI-Generated BPMN Workflow Automation

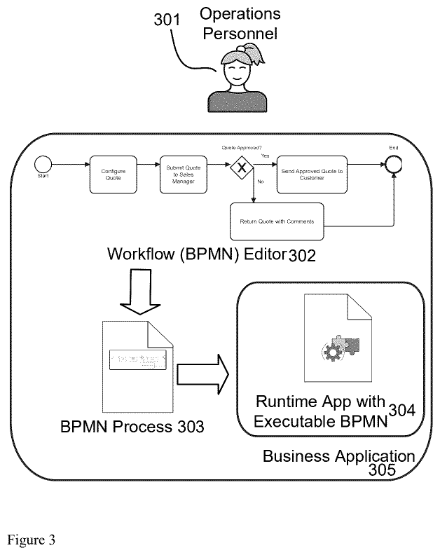

Once a multi-partner offering is defined, fulfilling or provisioning, that offering typically involves a business process that spans multiple systems (both internal enterprise systems and partner systems). As illustrated in FIG. 3, operations personnel (301) typically use a workflow editor (302) to model the relevant business process (e.g. sales motion, fulfilment steps etc.) into a software representation (303) e.g. BPMN encoded XML file, to govern its execution through a runtime application (304) integrated within the business application (305). The BPMN Process (303) generated in this step serves as the blueprint for orchestrating order fulfillment, integration calls, and lifecycle tracking of tasks related to an offering.

This invention includes a Workflow Generation Agent that automatically converts business process descriptions or requirements into an executable BPMN (Business Process Model and Notation) workflow. BPMN is a standard for modeling business processes in a machine-executable form. Leveraging AI here addresses the time-consuming step of manually creating orchestration logic for each new bundled offering. The Workflow Generation Agent uses advanced NLP and suitable large language model (LLM) to interpret textual process descriptions and produce a BPMN 2.0 compliant model. It can either derive the process directly from the offering definition (for instance, recognizing that “for this bundle, after an order is placed, notify Partner A's system to activate the service, update our billing system, and schedule device shipment with Partner B”) or from a separate description of the workflow. The agent identifies actors (partners, internal departments), tasks, decision points, and their sequence or parallelism, and then constructs the BPMN flow accordingly.

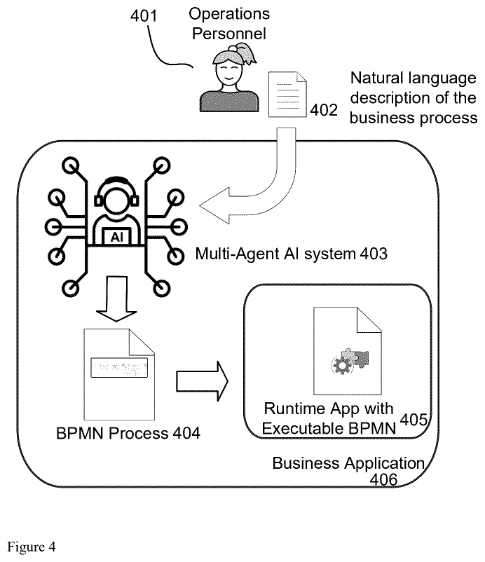

Notably, with this invention the system goes a step further by ensuring the generated BPMN workflow includes precise executable API calls and scripts to generate user interaction dialog, enabling immediate deployment and execution without additional manual coding. Each task in the BPMN model is linked to an implementation, often an API call or system operation (see next section on connectors). This bridges a gap in prior art: while researchers have shown Multi-Agent AI frameworks that iteratively refine process models from text, and thought leaders suggest letting AI agents define processes which can then be run on BPMN engines, those approaches often stop at producing the diagram. In contrast, this invention augments the workflow's text file with execution header and adds API calls to system managing the objects being modified or updated. In other words, this invention fully automates the pipeline from process description to running process. The BPMN workflow can be deployed on a standard workflow engine (which the agent can do via API) so that it's ready to execute real transactions. As shown in FIG. 4, operations personnel (401) provide a natural language description of the business process (402) to the Multi-Agent AI system (403), which directly produces an executable BPMN model (404) that is imported into the runtime application (406) of the business application (405). For example, continuing the telecom bundle scenario, the generated BPMN might include: (1) Receive Order→(2) Invoke Partner A Activation API→(3) Charge through BSS (Business Support System)→(4) Trigger Partner B device shipment→(5) Send confirmation to customer. Each step is a node in BPMN, with gateways for any conditional logic (e.g. if credit check fails, terminate or notify). By using BPMN, the process logic is not a black-box—it's a standard explainable workflow that stakeholders can review, which is valuable for compliance and transparency. Indeed, experts argue that even in an AI-driven future, having a “lingua franca” like BPMN for inter-agent communication about processes is crucial for clarity. A system based on this invention aligns with that vision by producing BPMN definitions that AI and humans alike can understand and verify. When a Multi-Agent AI system acts an assistant in accomplishing certain task, it is referred to as Multi-Agent AI assistant. The entire collaborative system of one or Multi-Agent AI assistants interacting with human or system is referred to as Multi-Agent AI framework.

The Workflow Generation Assistant may itself be implemented as a multi agent AI system: generating an initial workflow from text, then refining it with feedback (possibly simulating execution to check for errors or using a secondary AI agent to review for completeness). Recent research on multi-agent orchestration for process modeling shows that having one AI propose a model and others refine and validate it yields higher quality result. For instance, one agent could generate the BPMN, a second could act as a “compliance checker” agent to verify no required partner approval step is missing, and a third could simulate execution to ensure the flow runs without format errors (similar to testing for BPMN correctness.

Finally, by integrating this agent with the previous one, any change in the offering configuration can automatically trigger an update in the workflow, if needed. If a new partner is added to a bundle, the system can insert additional tasks for that partner's involvement. This continuous alignment between offering and process constitutes lifecycle management of the workflow. It ensures that the automated processes adapt in tandem with business changes-a key advantage for long-term maintainability.

An aspect of the disclosure herein includes a computer implemented method where a Multi-Agent AI system can help with the creation of business process workflows to a point where a human needs to validate and revise as needed. As per this invention, such agent takes the description of a business process in natural language and creates an executable workflow that drives the underlying business-software. As it categorizes the tasks into user tasks and service tasks and instruments with action or subtask accordingly. E.g. a user task is augmented to bring a screen to solicit input from the user whereas a service task is instrumented to update the object in the business software using its API.

### 3. API Discovery, Categorization, and Automated Connector Generation

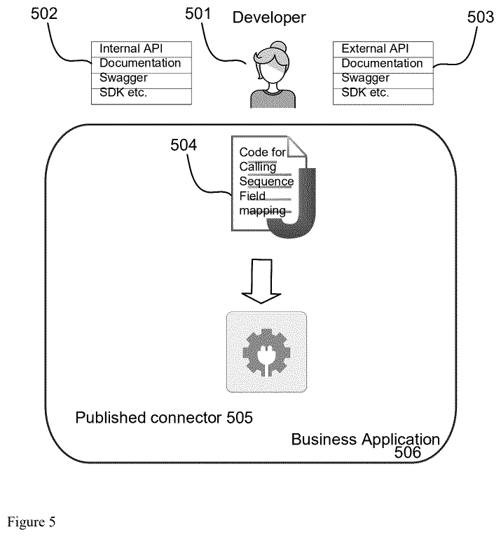

A core challenge in automating cross-organization workflows is connecting to each partner's IT systems. Partners typically expose APIs (REST, SOAP, etc.) or provide documentation for how to interact with their services (for provisioning, billing, data lookup, etc.). Setting up integrations to these APIs normally requires developers to study the docs and write connector code or use integration middleware. As shown in FIG. 5, a developer (501) gathers internal (502) and external (503) API documentation such as Swagger or SDKs, writes code specifying the calling sequence (504), and publishes a connector (505) including required field mappings (506) to facilitate integration. Subsequently, the connector can be invoked directly to perform tasks without manually executing individual steps. Connectors can be extended to include more API interaction or tasks.

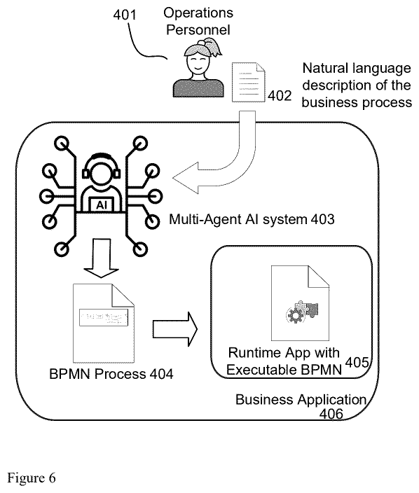

A system based on this invention dramatically accelerates this via an Integration/API Agent that performs AI-assisted API discovery, classification, and connector generation. The Multi-Agent AI system's Integration/API agent ingests and analyzes API documentation provided in various formats, including formal specifications such as OpenAPI (Swagger), developer guides, or natural language descriptions. Using NLP and possibly specialized parsers, it analyzes the API definitions to identify available operations and their inputs/outputs. It then uses this understanding to automatically generate “connectors”-which are software adapters or integration modules enabling the rest of the system to invoke those external APIs easily. In practice, a connector might be a piece of code (e.g. a wrapper class or an integration flow in an iPaaS) that takes standardized inputs from the BPMN workflow and calls the partner API, handling authentication, data mapping, and error handling. As illustrated in FIG. 6, a developer (601) provides API documentation for internal (602) and external (603) APIs and submits natural language instructions (605) to the Multi-Agent AI system (604) to create a categorized index of APIs (606). The developer can further instruct the AI (607) to generate or update connectors (608) based on the categorized API index, facilitating integration. The developer can evaluate, validate and revise the AI generated connector. For example, if Partner A's activation API is described in an Open API spec, the Integration Agent can parse it, determine the URL, required parameters (like customer ID, plan ID), and generate a function or low-code component to call it. It might categorize it as “Activation API” and link it to the context of “post-sale provisioning” so that the Workflow Agent knows to insert a call to it in the BPMN at the appropriate step. If documentation is only in natural language (e.g. “to activate a user, send a POST request to . . . with JSON payload . . . ”), an LLM-based parser can interpret this and similarly produce a structured action for it.

An aspect of this invention builds upon emerging trends in AI for integration. Boomi's recently patented AI features, for instance, assist users in constructing integration processes by suggesting the next steps or data mappings. However, those features guide a human integrator; the system as per this invention fully automates connector creation by reading API docs and producing the integration code, which is a substantial leap. Another related development is OpenAI's work on enabling natural language interfaces to invoke external APIs by integrating them with LLMs. In OpenAI's approach, if a user asks an AI assistant to perform an action requiring an external API (like “Book a flight”), the system can identify the relevant API and call it. An Integration Agent as per this invention operates on a similar principle of mapping high-level intents to API calls, but it proactively prepares the connectors in advance, during the design phase of the offering's workflow. Secondly, the Integration Agent as per this invention, is provided with the application's representation of entities and associated attributes so while writing connector it knows what the external API is to be mapped into. To ensure broad applicability, the connector generation is designed to handle a variety of API formats and industries. Whether it's a SOAP web service for a legacy BSS system or a RESTful JSON API for a cloud service, the agent can adapt its parsing strategy. This invention is agnostic to specific API standards and applies to any “interface definition” or “machine-readable service description.” Another aspect of this invention is API categorization—the agent can label APIs by function (billing, provisioning, customer info, etc.), which helps in automatically selecting the right API during workflow generation. Over time, the system could build a knowledge base of known API patterns (e.g. many partners have similar “create order” endpoints) and use machine learning to improve connector suggestions. This learning aspect is an embodiment (the system improving its connector generation model with training data from prior integrations).

By automating API connectivity, the system ensures that when the BPMN workflow runs, it can seamlessly communicate with all required external and internal systems. This completes the automation loop: the Offering Agent defines what the bundle is, the Workflow Agent defines how to fulfill it, and the Integration Agent provides the means to execute each step by interfacing with the necessary systems. The system progressively enhances its performance through continuous learning from past integrations and API interactions.

Another aspect of the disclosure herein includes a computer implemented method where a Multi-Agent AI system reads API documentation of a target system and categorizes APIs by their functionality. As per this invention, this Agent uses a language model that has been fine-tuned with APIs and their natural language description. As per another aspect of this invention, such Agent takes instruction in natural language and creates API call sequence to achieve the desired intent.

While the invention is described using multi-partner offering of products and services from various partners, it should be clear to the skilled in the art that the invention applies to single product offering from single entity as well.

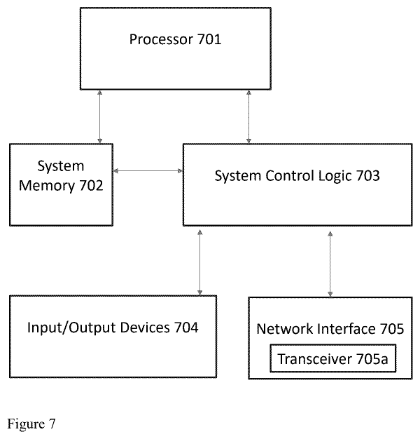

As shown in FIG. 7, the system comprises a processor (701) executing AI models, memory (702) for storing workflows and configurations, system control logic (703) managing interactions among AI agents, input/output devices (704) for user interaction, a network interface (705) for external communications, and a transceiver (705a) for network connectivity.

1. A computer-implemented method for configuring and automating multi-partner offerings, the method comprising:
a. receiving an input dataset comprising an unstructured description of a multi-partner product or service offering, including external reference data or product documentation;
b. using a natural language processing model within a multi-agent AI framework to interpret the input dataset and generate a structured offering definition specifying each product or service, associated partner metadata, constraints, and pricing definitions;
c. automatically constructing a business process workflow definition in a machine-executable process modeling notation that orchestrates fulfillment actions across enterprise systems and partner systems;
d. analyzing interface information and API documentation of the enterprise and partner systems to identify available APIs, authentication mechanisms, and integration endpoints required by the workflow;
e. generating software connectors dynamically configured based on the identified APIs, integration policies, and partner-specific requirements; and
f. deploying and executing the workflow definition such that, upon receiving an order or a lifecycle event, the workflow coordinates actions through the generated connectors, including automated error handling and retries for integration reliability and real-time monitoring of integration performance.

2. The method of claim 1, wherein the structured offering definition is refined using a machine learning model trained on historical offering data, partner interactions, customer preferences, and previous transaction outcomes.

3. The method of claim 1, wherein the generated workflow is automatically validated against predefined business rules, regulatory requirements, or industry standards before deployment.

4. The method of claim 1, wherein each step is performed by specialized AI agents within the multi-agent framework, each agent dedicated to tasks such as workflow generation, API integration, error detection, and compliance management.

5. The method of claim 1, wherein the structured offering definition incorporates external documentation or partner-provided catalogs retrieved dynamically via URLs provided within the input dataset.

6. The method of claim 1, wherein analyzing API documentation includes automatically identifying authentication requirements and configuring secure API interactions accordingly.

7. The method of claim 1, wherein workflow execution includes real-time monitoring of API interactions, enabling automatic detection of failures and triggering of alternative execution paths or retries based on predefined recovery policies.

8. The method of claim 1, wherein the software connectors generated support multiple integration protocols including REST, SOAP, and asynchronous messaging.

9. The method of claim 1, wherein the workflow dynamically adapts execution paths in response to real-time data from partner systems or changes in compliance and regulatory requirements.

10. The method of claim 1, wherein generating the structured offering definition includes creating a dependency graph to represent relationships and constraints between offering components.

11. The method of claim 1, wherein the workflow includes automatic verification of regulatory compliance based on jurisdiction-specific business rules prior to the execution of fulfillment actions.

12. A system for multi-partner offering automation, comprising: a natural language processing module configured to receive unstructured descriptions of product/service bundles involving multiple partner organizations and to output structured offering data models; a workflow automation module configured to generate executable process workflows from offering data models or textual process descriptions, the workflows defining coordinated tasks between an enterprise and partner systems; an API integration module configured to interface with data describing external and internal system APIs and to automatically generate connector components enabling invocation of those APIs; and an orchestration engine that is operatively coupled to the natural language processing module, the workflow automation module, and the API integration module, the orchestration engine coordinating the modules such that for each new or updated offering description the system (i) produces a structured definition, (ii) produces a corresponding workflow, and (iii) deploys integration connectors for any external system interactions required by the workflow, thereby providing end-to-end support for configuring, executing, and managing multi-partner offerings. A system for configuring and automating multi-partner offerings, comprising:
a. at least one processor;
b. a memory storing instructions that, when executed by the processor, cause the system to:
i. receive an input dataset containing an unstructured description of a multi-partner offering;
ii. interpret the dataset using a natural language processing model within a multi-agent AI framework to generate a structured offering definition including detailed partner metadata, pricing terms, and compliance requirements;
iii. construct a workflow model in a machine-executable business process modeling format that orchestrates fulfillment and lifecycle events;
iv. analyze available API documentation and dynamically generate software connectors that adapt to integration endpoints and authentication requirements;
v. deploy and execute the workflow in a runtime environment, wherein the system monitors execution, detects integration errors, and automatically adjusts API interactions to ensure reliable coordination among enterprise and partner systems;
vi. store structured offering definitions, executable workflows, and generated API connectors within memory for subsequent retrieval and execution.

13. The system of claim 12, wherein the AI agents operate in a distributed computing environment, enabling coordinated multi-party interactions across cloud and on-premise systems.

14. The system of claim 12, further comprising an interactive user interface allowing human review and approval of generated offerings and workflows prior to deployment.

15. The system of claim 12, wherein software connectors autonomously adapt to API schema changes detected during runtime operation.

16. The system of claim 12, wherein predictive analytics monitor historical API interaction data to proactively detect potential integration failures, enabling preemptive adjustments.

17. The system of claim 12, wherein workflow and integration execution logs are recorded within an immutable data storage medium to ensure auditability and traceability.

18. The system of claim 12, wherein execution data is continuously analyzed using machine learning algorithms to refine workflow structures and optimize future executions.

19. The system of claim 12, wherein structured offerings and workflows include automated version management, enabling historical version tracking, rollback, and audit of modifications.

20. A non-transitory computer-readable medium storing instructions executable by a processor to perform the method of claim 1, wherein the instructions, when executed, implement modules comprising an offering configuration engine, a workflow generation engine, and an integration connector engine.
